(19) United States
(12) Patent Application Publication
(10) Pub. No.: US 2003/0144768 A1
(43) Pub. Date: Jul. 31, 2003

(54) Method and system for remote reconstruction of a surface

(76) Inventors: Bernard Hennion, Saint Martin D'Uriage (FR); Agnes Guerraz, Le Gua (FR)

Correspondence Address: Eric B Meyertons, Conley Rose & Taylor, PO Box 398, Austin, TX, 78767-0398, US

(21) Appl. No.: 10/296,298

(22) PCT Filed: Mar. 14, 2002
(86) PCT No.: PCT/FR02/00912

(30) Foreign Application Priority Data
Mar. 21, 2001 (FR) 01/03828

(51) Int. Cl. G05D 1/00

(52) U.S. Cl. 701/2

(57) ABSTRACT

A method for remote reconstruction of a surface, in which a local system sends information on the position of a mobile element of said local system to a remote system, the mobile element of the local system replicating the position of the mobile element of the remote system, the remote system comprising a remote model of the surface, and a remote operator displaces the mobile element of the remote system, and when the mobile element of the local system comes into contact with said surface, said remote model is modified for each point of contact between the mobile element of the local system and said surface so that the remote model approximates said surface.

The present invention relates to the field of the remote construction of a surface, especially an uneven surface.

For the transmission of force feedback over a long distance, especially within the scope of developing distributed virtual worlds and of developing telepresence systems, the requirement to determine the coordinates of a surface away from a computing or control means becomes apparent, and to do so for the purpose of calibration.

Conventional methods, especially interpolation, smoothing, Lagrange, Hermite, etc. methods, generally use position data in space, data carefully chosen to obtain a result close to the real model. The resulting calculations are onerous and can hardly be carried out in real time. The quality of the result depends on the number of known points of the real object, on the relevance of the measured points and on the near homothety of the virtual and real models.

In the same way that digital video encoding techniques are based on knowledge of visual perception, and voice recognition techniques are based on knowledge of hearing, haptic techniques (from the Greek haptos: hand) are based on knowledge of movement.

There are two sorts of fine movements which can be carried out with the hand; ballistic movements, such as moving the hand toward a glass in order to grasp it and movements with touch feedback, such as that allowing, after grasping the glass and closing the thumb-fingers grip, the glass to be carried to its mouth. The brain is then continually informed of the force with which the hand tightens around the glass and of its weight which depends on the amount quantity of liquid therein. The brain then reacts by giving the motor instruction to “grip” this glass sufficiently tightly so that it does not fall, but not too tight, so as not to break it or expend energy needlessly.

Ballistic movements activate the motor reflex arc but they do not activate the touch feedback sensory reflex arc. The feedback of information may be a visual representation in space, but also a body map, that is to say a learnt or innate mental representation hardwired in the brain and which automatically generates the sequence of motor instructions to the muscles of the shoulder, of the arm and of the hand in order to perform this ballistic movement as a function of a particular mental representation of the space, especially of the assumed hand-glass distance.

For ballistic movements, it is sufficient to transmit information concerning the movement to the brain with a sampling frequency of 100 Hz. This means that if a sample of the signal is sent every 10 ms, the transmitted signal will contain all the information relevant to the ballistic movement.

Movements with touch feedback simultaneously activate the motor reflex arc and the sensory reflex arc. The brain closes the loop and, in humans, the complete cycle lasts less than 1 ms. The bandwidth of the sensory neurons located in the ends of the fingers, that is to say the maximum frequency of the mechanical signal that these neurons are capable of detecting and of transmitting to the brain, is greater than 500 Hz. If it is desired to encode a fine movement in a computer, the force feedback system used must itself have a high operating frequency, at least equal to twice the bandwidth of the fingers, according to Shannon's theorem.

In practice, force feedback systems on a local machine operate at a typical frequency of 1 KHz in a local closed loop, meaning that feedback is calculated then applied to their motors and then perceived by the hand every 1/1000 of a second. This makes it possible to avoid the effect known as the “electric toothbrush” effect: the instrument held in the hand must not give the impression of vibrating.

This frequency of 1 KHz results from the following compromise: it must be neither too low if the tactile impression is to be produced finely, nor too high if the computer is to have enough time to calculate the feedback force that will represent the fine simulation of the movement executed in the virtual mechanical world.

If now it is desired to transmit fine movements encoded by the force feedback system and fine movements with feedback via a telecommunications network, the problem is more complicated because of the generally much greater latency introduced by the network itself.

Thus, using ISDN technology, the latency is 30 ms, using ADSL technology, it is about 200 ms, and on the Internet, it can be as much as 6 s or even lead to the pure and simple rejection of the message. The ADSL and Internet latency varies because of the asynchronous nature of the networks. The frequency of 1 KHz is therefore much too high to be maintained if the closed loop includes a return trip via the network—the movement is encoded then transmitted via the network, it is applied to a remote object, the feedback from this object is in its turn encoded and sent back via the network.

A ballistic movement may be transmitted with a time-delay having an order of magnitude of 10 ms. In fact, sight is a monodirectional sense: the eye is a kind of camera recording a scene and the brain, to within a tolerance value, may perceive the precise visual film with a slight time-delay without disturbing the execution of the movement.

On the other hand, a fine movement with feedback requires a loop of less than a millisecond, the return trip for deciding the intensity of the force to be applied:

sending the instruction to the muscle via the motor sensory reflex arc,

mechanical action of the hand on the glass,

sensation at the ends of the fingers of touching the glass (increased contact pressure), and

return of this information to the brain via the tactile sensory reflex arc to allow the brain to decide how to adjust the force of the “grip”.

A method known as the “wave transform” method for trying to transmit a fine movement of this kind is nevertheless published by John Wilson and Neville Hogan of MIT under the title “Algorithms for Network-Based Force Feedback”, Fourth PHANTOM Users Group Workshop (PUG 99). This method simulates the time-delay introduced by the network by means of an artificial viscosity which stabilizes the feedback loop: the greater the time-delay introduced by the network, the more viscous the system.

The “wave transform” method consists in transposing into the force/velocity space the theory of passive quadripoles with pure time-delay which is well known for electrical voltage/current parameters. This theory is used to calculate incident and reflected electrical waves as a function of the characteristic impedance of the line. Transmission of the electrical signal is optimized if this line is terminated with the same characteristic impedance.

Ohm's law U=Z*I is transposed in mechanical space into the law F=viscosity*velocity and the “wave transform” method consists in adapting a virtual pure time-delay line by assigning it a characteristic impedance (in reality a viscosity) which is that of the remote-controlled robot. The signal is transmitted in the form of its Z transform, S(z)=Σ(s(t)*e^{(2i*πn*T)}) where T is the fixed time-delay of the network. The greater the time-delay introduced by the network, the greater the artificial viscosity that must be added to the line in order to stabilize the distributed mechanical simulation of the fine movement in a closed loop and in the network.

The movement sensation is undoubtedly distorted, but transmission of the useful signal is optimized. This method was published following the Fourth Users Group Workshop (PUG99).

The “wave transform” method requires a synchronous network, i.e. a network with a fixed known time-delay, for example an ISDN. It is based on the Z representation of sampled discrete signals whose period is equal to that of this known fixed time-delay of the network.

It is therefore inapplicable to message-based asynchronous networks of the Internet, ATM or UMTS type, which are characterized by a variable transmission time-delay and a rejection if the message is lost or takes too long to cross the network.

The problem of excessively fast timing of force feedback systems is exacerbated on these asynchronous networks, for which:

messages can be lost, rejected or fail to arrive if the acknowledgement is delayed for too long (TCP/IP),

messages which reach the correct destination take a variable time to cross the network,

they do not necessarily arrive in the order in which they were sent,

there is no common clock for the two machines accurate to within one millisecond.

The invention proposes to overcome the drawbacks of the prior art systems.

The invention proposes the remote reconstruction of a local surface in order to be able to calculate a reference point in a short time-period.

The invention especially proposes a control system for a remotely located feedback element capable of operating with data transmission on synchronous or asynchronous networks with a known or indeterminate time-delay.

The method for remote reconstruction of a surface, according to one aspect of the invention, comprises the following steps:

a local system sends information on the position of a mobile element of said local system to a remote system, the mobile element of the local system replicating the position of the mobile element of the remote system, the remote system comprising a remote model of the surface,

a remote operator displaces the mobile element of the remote system, and when the mobile element of the local system comes into contact with said surface, said remote model is modified for each point of contact between the mobile element of the local system and said surface so that the remote model approximates said surface. Thus, a calibration is carried out which means that the remote model accurately simulates the local surface.

In one embodiment of the invention, the remote model is initially a meshed flat surface. The remote model may initially be a flat assembly of contiguous triangular elements.

In one embodiment of the invention, the remote model overall approximates said surface along a translational movement normal to a portion of said surface normal to a portion of the remote model, up to a first point of contact of the mobile element of the local system with said surface.

The coordinates of said first point of contact may be predetermined along two axes of a three-dimensional coordinate system, leaving only the coordinate along a third axis of said three-dimensional coordinate system to be determined.

In one embodiment of the invention, a point of contact is a point in space common to the mobile element of the local system and to said surface and such that the mobile element of the local system exerts a predetermined force on said surface. Generally, said force will be normal to said surface.

Advantageously, the remote model comprises a plurality of nodes, one node approximates said surface by translation along an axis. The axis of translation may be parallel to said third axis. Alternatively, a node may approximate said surface by rotation about an adjacent node with conservation of the distance between said two nodes.

In one embodiment of the invention, the reaction force exerted by said surface on the mobile element of the local system is replicated by the mobile element of the remote system so that the operator experiences said reaction forces and is able to apprehend said surface.

Advantageously, during an initialization phase, the mobile element of the remote system replicates the position of the mobile element of the local system.

In one embodiment of the invention, the mobile element of the remote system exerts a braking force when the mobile element of the local system is displaced toward said surface in a part of the space contained between the model and said surface. Thus the operator experiences said braking force and may apprehend said model.

The invention also proposes a system for remote reconstruction of a surface. This system comprises a local system provided with a mobile element capable of coming into contact with the surface to be reconstructed, and a remote system provided with a mobile element capable of being manipulated by an operator, a remote model of the surface, and a means for modifying said remote model for each point of contact between the mobile element of the local system and said surface when the mobile element of the local system comes into contact with said surface, so that the remote model approximates said surface. The local system is provided with a means for sending information on the position of the mobile element of said local system to the remote system, and with a means for replicating the position of the mobile element of the remote system.

The invention also relates to a computer program comprising program code means for implementing the steps of the method when said program runs on a computer.

The invention also relates to a medium capable of being read by a device for reading program code means which are stored therein and which are capable of implementing the steps of the method, when said program runs on a computer.

Thus, it is possible to model and calibrate a remote three-dimensional shape or object having a completely free shape. The stream of haptic data and used to transmit the maximum amount of data concerning said remote shape.

The present invention is advantageously applied to bidirectional systems, for example robotic tele-echography which may be used in the field of obstetrics and abdominal examinations. A 3D virtual mannequin of a person can be remotely calibrated.

In the case of echography, the skin of the person is generally coated with a gel for suitable transmission of the ultrasound. The echographic probe could be remotely manipulated by an operator. Because of the presence of the gel, the force components applied by the patient on the probe may be considered as normal to the local surface of the skin. The probe has 6 degrees of freedom with force feedback along the three axes of a three-dimensional coordinate system and torque feedback also along the three axes of a three-dimensional coordinate system.

The system may also be put to good use by people having defective sight in order to apprehend a shape.

The system may also be applied to industrial applications of the robotic remote machining or remote control type in an environment hostile to humans or under low visibility. The system is well suited to carrying out remote palpations.

The present invention will be better understood and other advantages will become apparent on reading the detailed description of some embodiments taken by way of nonlimiting example and illustrated by the appended drawings, in which:

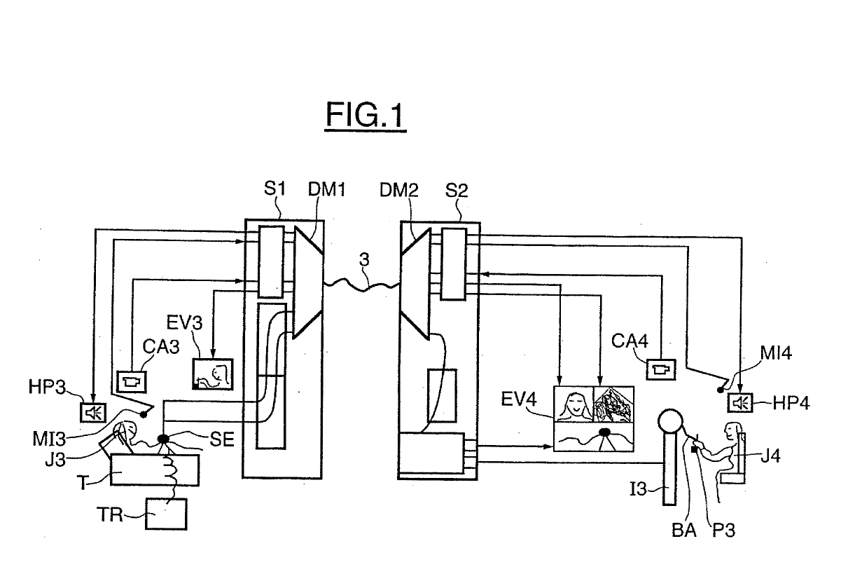

FIG. 1 is a schematic view of a system according to one embodiment of the invention;

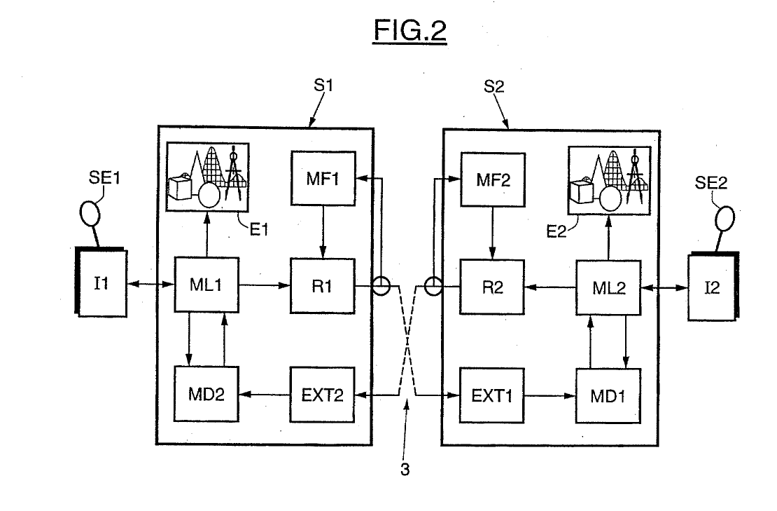

FIG. 2 is a detailed view of the systems S1 and S2 of FIG. 1;

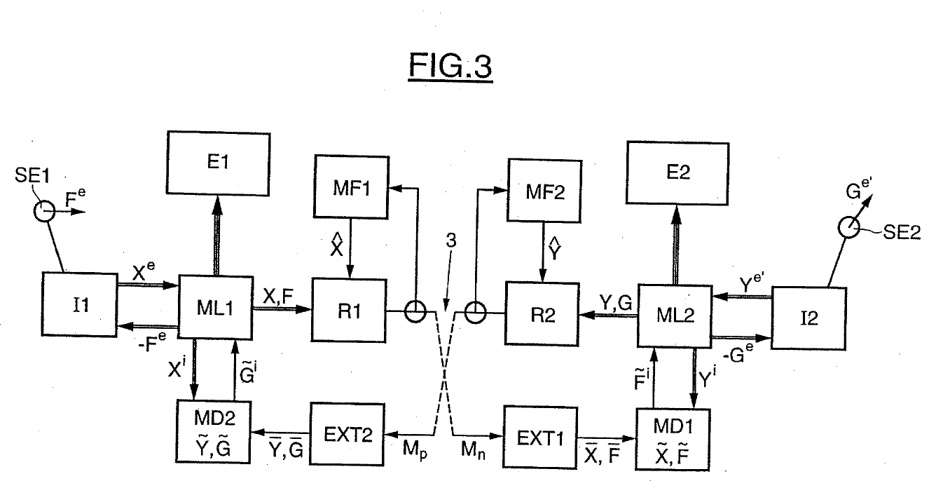

FIG. 3 is a more detailed view of FIG. 2;

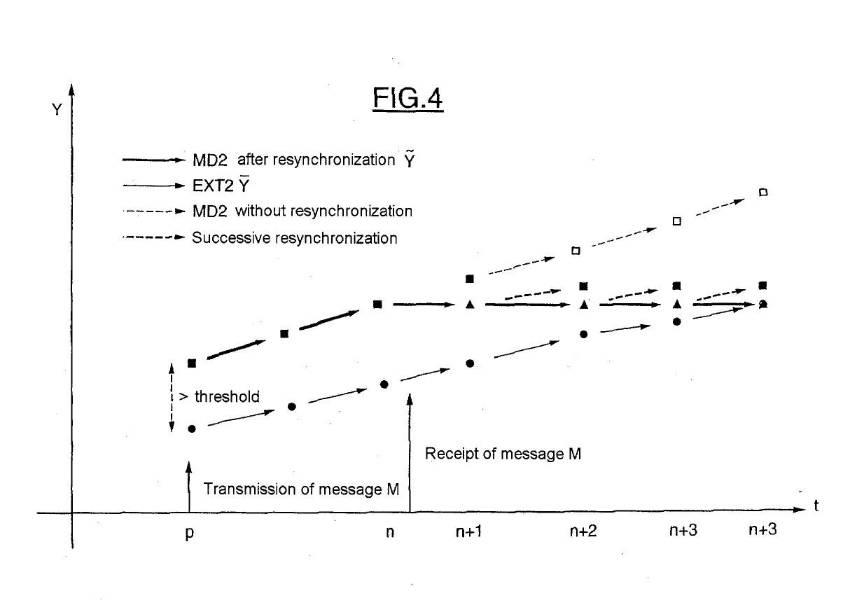

FIG. 4 shows alignment curves;

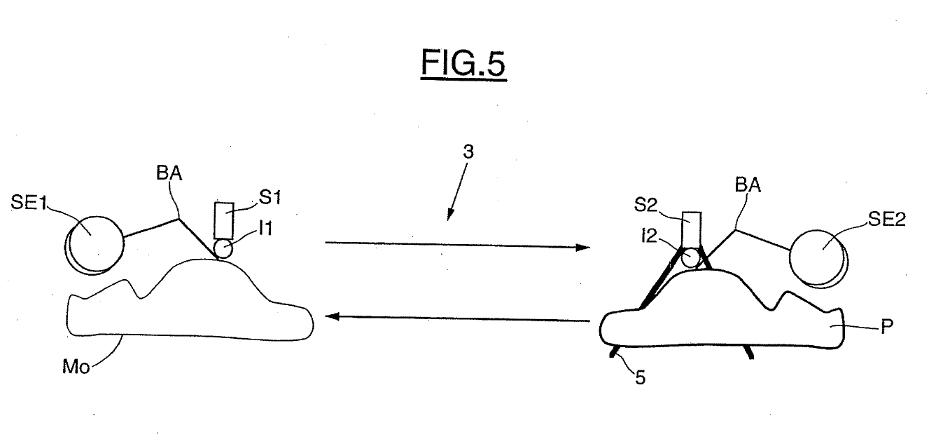

FIG. 5 is a schematic view of a system according to one embodiment of the invention;

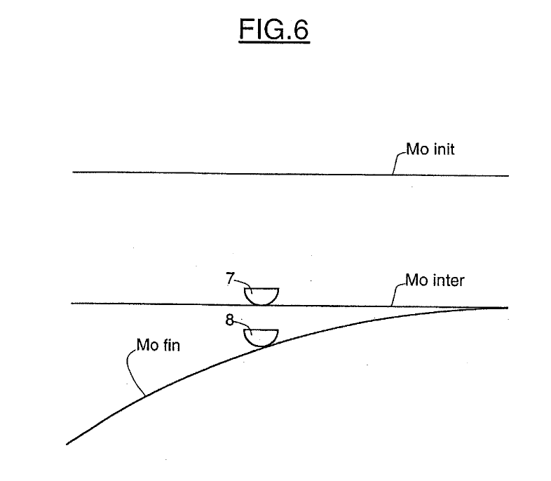

FIG. 6 is a schematic view of the reconstruction at one point; and

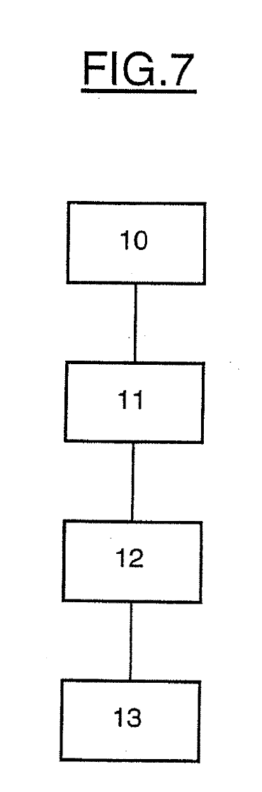

FIG. 7 is a flowchart of the steps of the method.

One embodiment of the invention intended for echography is illustrated in FIG. 1. Provision is made for a control system S1 installed, for example, in an institution which does not specialize in obstetrics, in an institution of a small town, or else in a vehicle for servicing rural regions. The system S2 is installed in a specialized hospital institution where highly qualified operators are available to carry out the echography operations, for example, in a regional or university hospital. A patient J3 lies on a bed or a table T. An echographic probe SE is in contact with his or her abdomen. A parameter adjustment table TR for the probe SE is installed nearby. The probe SE is connected to the system S1 and transmits echographic image data to said system S1, and exchanges data relating to the position and to the effects applied with the system S1. For reasons of clarity of the drawing, the support for the probe SE, which could be an articulated arm, has not been shown here. However, it is understood that it is a support allowing movement in space over several degrees of freedom, in general at least six so as to be able to take a suitable position in contact with the abdomen of the patient J3. Provision is made for a microphone MI3 and a loudspeaker HP3 connected to the system S1 and allowing the patient to converse with the remotely located operator. Provision is also made for a camera CA3 oriented toward the patient J3 and a video screen EV3 allowing the patient to see either the remotely located operator, or the echographic images. The camera CA3 and the video screen EV3 are also connected to the system S1. The systems S1 and S2, apart from the elements which have been described with reference to FIGS. 1 and 2, each comprise a multiplexer-demultiplexer DM1 and DM2 to allow the transmission of data over the network 3 which may, for example, be of ADSL type.

On the side of the system S2, the operator J4, who may be a doctor specialized in echography, manipulates a handle P3, the position in space of which will be replicated by the probe SE. The handle P3 is connected to an articulated arm BA, itself connected to an interface I3 of the type of the interfaces I1 and I2 described above and comprising one or more actuators and one or more position sensors and force sensors. The effect may be measured by measuring an energy parameter of the actuators, for example by the current consumed, again by means of a stress gauge. The interface I3 is connected to the system S2.

Provision is also made for a camera CA4 directed toward the operator J4 and whose images can be displayed on the screen EV3, a microphone MI4 and a loudspeaker HP4 allowing the operator J4 to converse with the patient J3. These elements are connected to the system S2. A large video screen EV4 will make it possible simultaneously to display a plurality of images, for example, an echographic image, an image of the face of the patient J3 and an image showing the position of the probe SE on the patient's abdomen.

As can be seen in FIG. 2, an echography system comprises an element SE1 with a shape close to an echographic probe for the user U1 and an echographic probe SE2 for a patient (not shown) Each element SE1, SE2 is connected to an interface I1, I2 comprising a means for applying a force to the element SE1, SE2, for example, an actuator of the electric cylinder type, and a means for measuring the force applied by the user U1 and the patient on the element SE1, SE2, for example, a torque sensor or else a stress gauge. The interface I1, I2 also comprises an acquisition map connected to the means for applying a force and to the measuring means and capable of exchanging digital data with another digital system such as a computer.

Each interface I1, I2 is connected to a control system S1, S2. In the case illustrated here, the systems S1 and S2 are identical. Only the system S1 will be described. However, it is possible to envision embodiments in which one of the two systems has a structure simplified with respect to the other.

In general, the system S1 may be in the form of a computer, of the personal computer type, generally provided with at least one microprocessor, volatile and nonvolatile memories, a communication bus, input and output ports and one or more software programs stored in memory and capable of being executed by the microprocessor.

The system S1 is connected, on one hand, to the interface I1, for example, by an RS 232 bus, and to the system S2 by a communication network, overall referenced 3, and which could be of the synchronous type, for example ISDN or asynchronous, of ATM, UMTS or else Internet type (TCP/IP). The system S1 is located close to the user U1, for example, in the same room. The system S2 is located at some distance from the system S1, a distance which may range from a few meters to a few thousand kilometers. In other words, the system S1, the interface I1, the element SE1 and the user U1 are placed locally while the system S2, the interface I2, the element SE2 and the patient are placed distally with respect to the previous components.

More specifically, the system S1 comprises a local model ML1 capable of sending a setpoint to the interface I1 and of receiving from said interface I1 a variable measured by the interface I1, for example, the position X of the element SE1. The setpoint may be a force or torque variable and is denoted Fₑ. The system S1 comprises a remote model MD2 provided to calculate a state of the local model ML2 of the system S2. The remote model MD2 of the system S1 is capable of receiving data coming from the system S2, or receiving data coming from the local model ML1 and of sending data toward the local model ML1. More specifically, the system S1 comprises an extrapolator EXT2 receiving data from the system S2 via the communication network 3 for processing a resynchronization message coming from the system S2 and transmitting update data to the remote model MD2 as a function of the resynchronization message last received.

The system S1 comprises a screen E1 connected to the local model ML1 for displaying data from the local model ML1, for example, a curve checking the change with time of the applied forces and of the positions of the elements SE1 and SE2.

The system S1 comprises a resynchronizer R1 receiving data from the local model ML1 and capable of sending output data intended for the system S2, in particular, intended for the extrapolator EXT1 of the system S2. The resynchronizer R1 is capable of preparing data for sending them in the form of a resynchronization message which will be able to include a date, the position X of the element SE1, the force F applied to the element SE1 on said date together with the force applied to the element SE1 at an earlier date.

Furthermore, the system S1 comprises a phantom model MF1 which also receives resynchronization messages coming from the resynchronizer R1 of the system S1 and which calculates state variables of the interface I1 according to the resynchronization messages sent by the resynchronizer R1 and received by the system S2. In other words, the phantom model MF1 carries out a calculation from the same data as those received by the remote model MD1 of the system S2. Thus, the phantom model MF1 makes it possible to model the variables of the interface I1 as they are modeled by the system S2.

The output of the phantom model MF1 is connected to the resynchronizer R1 which compares the calculation of the state variable coming from the phantom model MF1 and the state variables coming from the local model ML1. In the event of a difference greater than a predetermined threshold, the resynchronizer R1 sends a resynchronization message intended for the phantom model MF1 and for the extrapolator EXT1 of the system S2. Thus, the volume of data exchanged between the systems S1 and S2 is relatively low insofar as a resynchronization message is only sent if one of the two systems S1, S2 considers that the other system S2, S1 is no longer in a position to suitably calculate these state variables.

The operation of the system will be better understood with reference to FIG. 3. For the user U1, the state vector X is broken down into three parts: X^{e}, a variable located at the interface with the element SE1, X^{m}, an internal variable of the mechanical model of the user U1 and Xⁱ, an interaction variable located at the interface with the other participant. Similarly, the variable associated with force or torque F breaks down into: F^{e}, the force exerted by the user U1 on the element SE1, F^{m}, the force applied by the weight, the other objects, other possible participants, and the force Fⁱ exerted by the user U1 on the patient. Similarly, the state vector Y of the patient breaks down into Y^{,e}, Y^{,m} and Y^{,i} and the associated coupling force vector G breaks down into G^{,e}, G^{,m} and G^{,i}. The user U1 and the patient are in virtual contact. We therefore have Xⁱ=Yⁱ. The law of action and reaction gives: Fⁱ+G^{,i}=0.

At each time step, the interface I1 picks up the position X^{e}ₙ and transmits it to the local model ML1. The interface I1 receives the setpoint force F^{e}ₙ coming from the local model ML1 and controls its actuator or actuators with the feedback force −F^{e}ₙ. Similarly, the interface I2 picks up the position Y^{,e}ₙ and transmits it to the local model ML2 and receives the force G^{,e}ₙ coming from the local model ML2 controls its actuator or actuators with the feedback force −G^{,e}ₙ.

At the start of time n+1, the local model ML1 receives the position X^{e}ₙ₊₁ of the interface I1, the interaction calculation \tilde{G}ⁱₙ₊₁, of the remote model MD2 and the prerecorded intrinsic variables F^{m}ₙ₊₁. The local model ML1 calculates the force applied by the participant J1 on the patient: Fⁱₙ₊₁=\tilde{G}ⁱₙ₊₁, the force applied by the user U1 to the element SE1: F^{e}ₙ₊₁=B^{ee-1}{X^{e}ₙ₊₁−X^{e}ₙ−A^{e}Xₙ−B^{em}F^{m}ₙ₊₁+B^{ei}\tilde{G}ⁱₙ₊₁}, the matrices A and B being those of the change of the user U1 with X=AX+BF. The local model ML1 again calculates:

$${X}_{n + 1}^{m , i} = {X}_{n}^{m , i} + {A}^{m , i} {X}_{n +} {B}^{m , i} ⌊ \begin{matrix}{F}_{n + 1}^{e} \\ {F}_{n + 1}^{m} \\ - {\tilde{G}}_{n + 1}\end{matrix} ⌋$$

The local model ML1 sends Xₙ₊₁ and Fₙ₊₁ to the resynchronizer R1, the setpoint −F^{e}ₙ₊₁ to the interface I1 and the position variable Xⁱₙ₊₁ to the remote model MD2.

If the phantom model MF1 does not receive a message from the resynchronizer R1, it calculates \hat{F}ₙ₊₁+\hat{F}ₙ+K₁, where K₁ is supplied by the system S2, and the position calculation \hat{X}ₙ₊₁=(I+A)\hat{X}ₙ+B\hat{F}ₙ₊₁, that is to say the mechanical state of the user U1 as might be predicted by the system S2. Here, I is the identity matrix.

On reception of a resynchronization message Mₙ={n,\overline{X}ₙ,\overline{F}ₙ and \overline{F}ₙ₋₁} coming from the resynchronizer R1, the phantom model MF1 carries out the following resynchronization: \hat{X}ₙ=\overline{X}ₙ,\hat{F}ₙ and K1 \overline{F}ₙ−\overline{F}ₙ₋₁.

The recynchronizer R receives, at each time step n, the position variable Xₙ and the force variables Fₙ and Fₙ₊₁ coming from the local model ML1, and the calculation \hat{X}ₙ coming from the phantom model MF1. It compares the absolute value of the difference between the position variable Xₙ and the calculation \hat{X}ₙ to a predetermined threshold and does nothing if said absolute value is less than said threshold. Otherwise, it composes a resynchronization message Mₙ={n,Xₙ,Fₙ,Fₙ₋₁}. The resynchronizer R1 sends the resynchronization message Mₙ to the phantom model MF1 so that it is resynchronized immediately and with the remote model MD1 via the extrapolator EXT1 of the system S2 so that it is resynchronized as early as possible.

The extrapolator EXT2 of the system S1 makes it possible to produce a synchronization. This is because the message Mₚ={p Yₚ,Gₚ,Gₚ₋₁} emitted by the resynchronizer R2 of the system S2 arrives at the system S1 at a time between n and n+1. However, the message Mₚ is stamped by the date p coming from the system S2. The extrapolator EXT2 calculates K₂=Gₚ−Gₚ₋₁ and resynchronizes the remote model MD2 by carrying out: \overline{G}ₚ+Gₚ and \overline{Y}ₚ=Yₚ then at the following times and whenever: j=p, . . . ,n,\overline{G}ⱼ₊₁=\overline{G}ⱼK2 and \overline{Y}ⱼ₊₁=\overline{Y}ⱼ+C\overline{Y}ⱼ+D\overline{G}ⱼ₊₁, C and D being the matrices equivalent to the matrices A and B for the patient. The extrapolater EXT2 transmits the results of the resynchronization: \overline{Y}ₙ₊₁,\overline{G}ₙ₊₁ and K₂ to the remote model MD2.

The remote model MD2 of the system S1 is resynchronized on reception of a message coming from the extrapolater EXT2 by taking the values supplied by said extrapolater EXT2:

\tilde{G}ₙ₊₁=\overline{G}ₙ₊₁,\tilde{Y}ₙ₊₁=\overline{Y}ₙ₊₁ and \tilde{K}₂=K₂

Outside reception of such a message, and at each time step, the remote model MD2 receives the position variable Xⁱₙ₊₁ coming from the local model ML1 and carries out a predictive calculation:

\tilde{G}^{′,m′}ₙ₊₁=\tilde{G}^{e′,m′}_{n\tilde{K}}^{e′,m′}2

\tilde{G}ⁱₙ₊₁=Dⁱⁱ⁻¹{Xⁱ° ₙ₊₁−\tilde{Y}ⁱₙ−C\tilde{Y}ⁱₙ−D^{e′}G^{′}ₙ₊₁−D^{m′}G^{m′}_{n+1}}

\tilde{Y}^{e′,m′}ₙ₊₁=\tilde{Y}^{e′,m′}ₙ+C^{e′,m′}\tilde{Y}ₙ+D^{e′,m′}\tilde{G}ₙ₊₁

\tilde{Y}ⁱₙ₊₁=Xⁱₙ₊₁

The remote model MD2 transmits the prediction of position variable relative to the patient: \tilde{G}ₙ₊₁ to the local model ML1.

Preferably, the extrapolater EXT1 carries out a bevel resynchronization which makes it possible to smoothe the changes, see FIG. 3.

Instead of suddenly changing the estimate of the position variable Y to the variable \overline{Y} as calculated by the extrapolater EXT2, in the manner explained above, the resynchronization is carried out in four steps between times n and n+4 according to the following calculation:

k=|\tilde{Y}ₙ₊₁:=\overline{Y}ₙ₊₁/threshold+1;

If k=1, then \tilde{Y}ₙ₊₁−\overline{Y}ₙ₊₁

Otherwise j=n,

\overline{G}ⱼ₊₁=\overline{G}ⱼ+K2

\overline{Y}ⱼ₊₁=\overline{Y}ⱼ+C\overline{Y}ⱼ+D\overline{G}ⱼ₊₁

\tilde{Y}ⱼ₊₁:=\tilde{Y}ⱼ+C\tilde{Y}ⱼ+D\overline{G}ⱼ₊₁

\tilde{Y}ⱼ₊₁=(\overline{Y}ⱼ₊₁+(K−1)\tilde{Y}ⱼ₊₁)/k

j:=j+1

If k is greater than 2, then k:=k−1

Otherwise, the loop is exited and \tilde{Y}ⱼ₊₁=\overline{Y}ⱼ₊₁. The bevel resynchronization allows the system to operate more smoothly, which is better appreciated by users and entails fewer mechanical stresses.

More generally, the phantom model MF1 receives the same data as the remote model MD1 of the other system and makes it possible to carry out the same simulation as said other system. In other words, a search is conducted to find out what the other system does not know for the purpose of resynchronization. The resynchronizer operates blindly with respect to the other system and enables simulation to continue in the absence of relevant data transmitted by a resynchronization message coming from the other system. The extrapolator EXT2, in particular in the case of bevel resynchronization, makes it possible to take account of the movement as measured by the other system during the transmission time-delay due to the communication network. In a simplified variant, it is perfectly conceivable for either or both of the systems to have no phantom model. A number of systems greater than two can also be made to work together.

The local models represent the mechanical models of the two users. The remote models represent a remote replication of the local mechanical models which is necessarily approximate because of the time-delays on transmitting the states of the local models via the communication network. The phantom models represent an approximate local copy of the remote models. The remote models and the phantom models both operate in predictor-corrector mode. The extrapolators extrapolate the messages received with a certain time-delay in order to synchronize the remote models to the clock value of the other system. The resynchronizers evaluate the need to launch a resynchronization method into the communication network as soon as there is too great a difference between the local models and the local predictive control phantom models of the remote predictive models. The resynchronizers make it possible to limit the number of messages sent through the communication network in order to avoid congestion thereon. Within a system, information can be exchanged at the rate of 1 kHz. Between the systems, and therefore via the communication network, messages are exchanged if one of the resynchronizers considers it to be necessary.

FIG. 5 shows another embodiment particularly suitable for echography. The echographic probe SE2 supported by the arm BA connected to the interface I2, itself connected to the system S2, is placed close to the patient P. These elements are supported by a support 5. The system S1, the interface I1 and a mobile element SE1 of the same external shape, the same mass and the same inertia as the probe SE2 are placed in a remote location.

The remote model Mo is shown in fine line in its final state, that is to say extremely close to the shape of the patient P. The mobile element SE1 is in this case placed in a rest state, in a position relative to the remote model Mo identical to the position of the probe SE2 relative to the patient P and separate therefrom. The mobile element SE1 will be grasped by a practitioner in the same way as a real echographic probe would have been and will descend progressively downward. The echographic probe SE2 follows the same displacement as the mobile element SE1. First of all, by moving the mobile element SE1, the practitioner will place the echographic probe SE2 on the highest surface of the patient, usually the top of his or her abdomen. The feedback force exerted by the abdomen of the patient P on the probe SE2 is remotely copied such that the practitioner handling the mobile element SE1 experiences the same effect, in other words, the same feedback force as if he were handling a real echographic probe against the abdomen of a patient.

From the top of the abdomen of the patient P, the practitioner handling the mobile element SE1 by displacing it both vertically and horizontally will gradually reveal the contour of the patient P, possibly with the help of a display screen such as the screen EV4 illustrated in FIG. 1. While manipulating the mobile element SE1, the practitioner will reveal the abdomen of the patient P to the probe SE2 which replicates the movement thereof. The force exerted by the abdomen of the patient on the probe SE2 is replicated by the mobile element SE1.

Since the positions of the mobile element SE1 and of the probe SE2 are virtually identical, the mobile element SE1 is positioned almost identically to the position which a real probe traveling over the abdomen of the same patient would have. The system S1 records the various positions of the mobile element SE1, which makes it possible, on the basis of a sufficient number of measurement points, to carry out a three-dimensional reconstruction of the outer surface of the patient's abdomen, and therefore to obtain the remote model Mo.

It will be possible to provide a feedback force range in which the system S1 will consider that the mobile element SE1 is in a position corresponding to the surface of the patient's abdomen. Above the upper limit of the range, it will be considered that the mobile element SE1 is pushed too far into the abdomen. Below the lower limit of the range, it will be considered that there is no contact and that the mobile element is located away from the outer surface of the abdomen of the patient P.

FIG. 6 is a diagram illustrating the steps of generating the remote model. First of all, the remote model is in the form of an initial model Moᵢₙₜₑᵣ, which is a meshed flat surface, seen here in section. Next, the practitioner positions the echographic probe SE2 on the top of the abdomen of the patient P by manipulating the mobile element SE1. The initial model Moᵢₙₜₑᵣ then becomes an intermediate model Moᵢₙₜₑᵣ, still in the form of a flat surface, but tangent to the top of the patient's abdomen. In other words, the vertical coordinates of the points of the model have been decreased by the distance separating the initial model Moᵢₙᵢₜ from the top of the patient's abdomen, the initial Moᵢₙᵢₜ and intermediate Moᵢₙₜₑᵣ models being horizontal planes.

The practitioner then shifts the probe SE1 horizontally and takes it, for example, to position 7 level with the intermediate model Moᵢₙₜₑᵣ, then takes the mobile element to position 8, such that the echographic probe SE2 is in contact with the abdomen of the patient P. As soon as the feedback force exerted by the abdomen of the patient P on the probe SE2 exceeds the lower limit of the range and is transmitted to the system S1, said system S1 records the position as belonging to the upper surface of the abdomen of the patient P. In practice, the practitioner will be able to carry out curved movements so that the probe SE2 follows the upper surface of the abdomen of the patient P, and this both for the patient's comfort and the speed of the method. Furthermore, during any displacement of the mobile element SE1 beyond the model, provision can be made for a slight feedback force to be exerted by the mobile element SE1 on the practitoner's hands so that said crossing is perceptible to him. Said force will be controlled by the system S1 and applied by the interface I1, and it will be adjustable while remaining less than the lower limit of said range. It will be possible for said force to comprise a constant part similar to dry friction and a variable part proportional to the speed of displacement of the mobile element SE1.

FIG. 7 shows schematically the various steps of the method. In the initialization step 10, the probe SE2 and the mobile element SE1 are placed in a standby or rest position, allowing the patient P to get onto an examination table or to leave such a table. In step 11, the practitioner controls the approach of the probe SE2 toward the top of the abdomen of the patient P. In step 12, contact between the probe SE2 and the top of the patient's abdomen, recording by the system S1 of the coordinates of the first point of contact and the displacement of the remote model Mo from the initial remote model Moᵢₙᵢₜ to the intermediate remote model Moᵢₙₜₑᵣ takes place. In step 13, the practitioner passes the probe SE2 over the upper surface of the patient's abdomen. Each time a point of particular coordinates is considered as belonging to the upper surface of the abdomen of the patient P, the intermediate remote model Moᵢₙₜₑᵣ is deformed mesh by mesh or node by node so that the shape of the upper surface of the abdomen of the patient P is closely matched. Thus, the final remote model Mo_{fin} is gradually achieved.

The remote model Mo may comprise a variable or fixed mesh size. It would be possible to implement a resegmentation in order to refine the model in certain regions.

At the end of this calibration, the system S1 stores the final remote model in a memory, which allows it to react with an extremely brief response time, even if the transmission network 3 suffers from high transmission time-delays. Subsequently, when the practitioner displaces the mobile element SE1 crossing over the final remote model, the system S1 will apply a force to the mobile element SE1, simulating the feedback force from the abdomen of the patient P on the probe SE2. By possibly adding thereto a friction limit so as to avoid excessively rapid movements of the mobile element SE1 and therefore of the echographic probe SE2.

The invention therefore implements deformation of a geometrical mesh by the movement of the practitioner using it. The remote calibration of the virtual mannequin or remote model is carried out by intuitive scanning by the practitioner using it so as to strecth the starting mesh or initial remote model to the shape of the patient whose build, and especially whose stage of pregnancy, are extremely variable from one person to another. It is thus possible to palpate a person or the object located at a distance from a control station, which makes it possible to approximate a three-dimensional shape and to apprehend the shape of the person or of the object, the presence of a camera not being indispensable. In the context of an application already using a force feedback system, the proposed method allows the remote reconstruction of the three-dimensional shape without resorting to earlier methods such as laser recording or stereophotography.

1. A method for remote reconstruction of a surface, in which:
a local system sends information on the position of a mobile element of said local system to a remote system, the mobile element of the local system replicating the position of the mobile element of the remote system, the remote system comprising a remote model of the surface,
a remote operator displaces the mobile element of the remote system, and when the mobile element of the local system comes into contact with said surface, said remote model is modified for each point of contact between the mobile element of the local system and said surface so that the remote model approximates said surface.

2. The method as claimed in claim 1, in which the remote model is initially a meshed flat surface.

3. Method according to claim 1 or 2, in which the remote model overall approximates said surface along a translational movement normal to a portion of said surface and normal to a portion of the remote model, up to a first point of contact of the mobile element of the local system with said surface.

4. The method as claimed in any one of the preceding claims, in which a point of contact is a point in space common to the mobile element of the local system and to said surface and such that the mobile element of the local system exerts a predetermined force on said surface.

5. The method as claimed in any one of the preceding claims, in which a remote model comprises a plurality of nodes, one node approximates said surface by translation along an axis.

6. The method as claimed in any one of the preceding claims, in which the reaction force exerted by said surface on the mobile element of the local system is replicated by the mobile element of the remote system so that the operator experiences said reaction force and is able to apprehend said surface.

7. The method as claimed in any one of the preceding claims, in which, during an initialization phase, the mobile element of the remote system replicates the position of the mobile element of the local system.

8. The method as claimed in any one of the preceding claims, in which the mobile element of the remote system exerts a braking force when the mobile element of the local system is displaced toward said surface in a part of the space contained between the remote model and said surface.

9. A system for remote reconstruction of a surface, characterized in that it comprises a local system (S2) provided with a mobile element (SE2) capable of coming into contact with said surface to be reconstructed, and a remote system (S1) provided with a mobile element (SE1) capable of being manipulated by an operator, a remote model (Mo) of the surface, and a means for modifying said remote model for each point of contact between the mobile element of the local system and said surface when the mobile element of the local system comes into contact with said surface, so that the remote model approximates said surface, the local system being provided with a means for sending information on the position of the mobile element of said local system to the remote system, and with a means for replicating the position of the mobile element of the remote system.

10. A computer program comprising program code means for implementing the steps of the method according to any one of claims 1 to 8, when said program runs on a computer.
